(19) United States
(12) Patent Application Publication
(10) Pub. No.: US 2025/0149845 A1
(43) Pub. Date: May 8, 2025

(54) FORWARD RAMAN PUMPING WITH RESPECT TO DISPERSION SHIFTED FIBERS

(71) Applicant: Fujitsu Limited, Kawasaki-shi, Kanagawa (JP)

(72) Inventor: Youichi AKASAKA, Plano, TX (US)

(73) Assignee: Fujitsu Limited, Kawasaki-shi, Kanagawa (JP)

(21) Appl. No.: 18/502,934

(22) Filed: Nov. 6, 2023

(51) Int. Cl. H01S 3/094; H01S 3/067; H01S 3/30

(52) U.S. Cl. CPC H01S 3/094003; H01S 3/06766; H01S 3/302

(57) ABSTRACT

According to an aspect of an embodiment, an optical amplification method may include identifying a first range of signal wavelengths that correspond to a first optical signal configured to propagate via an optical fiber. The method may further include generating a pumping signal having a range of pumping wavelengths, the range of pumping wavelengths based on a range of dispersion wavelengths, which correspond to the range of pumping wavelengths, not overlapping with the first range of signal wavelengths. The pumping signal may be provided to the optical fiber having the optical signal propagating thereon.

### FIELD

The embodiments discussed in the present disclosure are related to Raman amplifiers.

### BACKGROUND

Telecommunications systems, cable television systems and data communication networks use optical networks to convey information between remote points. In an optical network, information is conveyed in the form of optical signals through optical fibers or other optical media. The optical networks may include various components such as amplifiers, dispersion compensators, multiplexer/demultiplexer filters, wavelength selective switches, couplers, etc. configured to perform various operations within the optical network. Further, optical pumping may be used to amplify optical signals that propagate through optical networks by interacting the optical signals with pumping signals.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, an optical amplification method may include identifying a first range of signal wavelengths that correspond to a first optical signal configured to propagate via an optical fiber. The method may further include generating a pumping signal having a range of pumping wavelengths, the range of pumping wavelengths based on a range of dispersion wavelengths, which correspond to the range of pumping wavelengths, not overlapping with the first range of signal wavelengths. The pumping signal may be provided to the optical fiber having the optical signal propagating thereon.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example embodiment of an optical amplification system configured to perform pumping of optical signals;

FIG. 2A-2C illustrate example graphs representing interactions between different wavelengths of optical signals and pumping signals;

FIG. 3 is a flow chart of an example method of performing optical pumping; and

FIG. 4 is a block diagram of an example computing system, all arranged in accordance with some embodiments of the present disclosure.

### DESCRIPTION OF EMBODIMENTS

Optical networks may include nodes that may be configured to communicate information to each other via optical signals carried by optical fibers. In some circumstances, amplification of the optical signals within the optical fibers may enable the optical signals to travel a greater distance by compensating for losses that may affect the optical signal, such as degradations of the optical signal due to a noisy channel within the optical networks.

Amplification of optical signals within an optical network may be obtained by optical pumping, which may be performed by an optical amplifier. In some circumstances, an optical amplifier may be suited to produce a linear amplification of signals by an energy transfer of stimulation ions within an optical fiber. Additionally or alternatively, an optical amplifier configured to produce Raman gain (referred to as a “Raman amplifier”) may be suited to produce nonlinear amplification of signals by energy transfer of bonded elements within an optical fiber. In some embodiments, the optical amplification may include a pumping signal. For instance, a pump source may generate the pumping signal to be launched into the optical fiber. The pumping signal may interact with molecules and/or ions of the optical fiber which may cause scattering of energy of the pumping signal. Scattered energy may be transferred from the pumping signal to the optical signal, amplifying the optical signal. In some embodiments, the pumping signal may be a higher intensity than the optical signal.

In some embodiments, the Raman amplifier may be configured to perform reverse pumping. For instance, the pumping signal may be launched into the optical fiber from an output end. The pumping signal may propagate through the optical fiber in an opposite direction than the optical signal. In reverse pumping, interaction between the pumping signal and the optical signal is reduced as the pumping signal is traveling in the opposite direction. The reduced interaction may mitigate a portion of pump-induced noise (e.g., noise added to the optical signal because of the pumping signal). However, noise reduction effects using different noise reduction techniques (e.g., type of fiber, Raman gain flattening, signal conditioning, optimized pump source, etc.) may not be as effective with the reverse pumping which may make it difficult to adjust and/or reduce the noise to meet system specifications.

In some embodiments, the Raman amplifier may be configured to perform forward pumping. For instance, the pumping signal may be launched into the optical fiber from an input end. The pumping signal may propagate through the optical fiber in the same direction as the optical signal. As the pumping signal travels in the same direction as the optical signal, the interaction between the pumping signal and the optical signal may increase which may cause additional noise to the optical signal. Some current approaches to forward-pumping Raman amplification may utilize incoherent pumps which may have a wide bandwidth (e.g., 20-30 nm). The wide bandwidth may increase the interaction between the pumping signal and the optical signal.

In some instances, the interaction between the optical signal and the pumping signal may be generated by dispersion of signals (e.g., of the optical signal and/or the pumping signal) within the optical fiber. For instance, the signals may include ranges of wavelengths including different wavelengths as the signals enter a medium such as the optical fiber. As the signals travel through the optical fiber, different wavelengths within the signals may travel at different speeds. The different wavelengths may cause dispersion effects and/or spreading of the signals over different wavelength ranges. In these instances, even with optical signal and the pumping signal generated at different wavelengths, the optical signal and the pumping signal may still interact due to the dispersion, causing and/or adding noise to the optical signal.

In some embodiments, the dispersion effects may occur with respect to zero dispersion wavelengths of the optical fiber. The zero dispersion wavelengths may refer to specific wavelengths at which the group velocity dispersion of the signals traveling through the optical fiber becomes zero. As there is no dispersion at the zero dispersion wavelengths, the group velocity dispersion occurs on both sides of the zero dispersion wavelengths. The group velocity dispersion may become more significant as the signals move away from the zero dispersion wavelengths, causing increased dispersion effects and pulse spreading. For instance, as the signals move toward shorter wavelengths away from the zero dispersion wavelengths, the optical fiber may cause shorter wavelengths to travel slower than longer wavelengths. In another instance, as the signals move toward longer wavelengths from the zero dispersion wavelengths, the optical fiber causes the longer wavelengths to travel slower than the shorter wavelengths.

In some instances, aligning the signals with the zero dispersion wavelengths of the optical fiber may help reduce pulse dispersion of the optical signals which may help maintain signal quality and enable high data rates. However, aligning the signals with the zero dispersion wavelengths may cause increased susceptibility to nonlinear effects. For example, self-phase modulation and cross-phase modulation may apply more which may cause signal distortion and degrade signal quality.

According to one or more embodiments of the present disclosure, a pumping signal of a forward-pumping Raman amplifier may be configured to reduce interaction between signals corresponding to the pumping signal and an optical signal, which may reduce noise. For instance, the pumping signal may be configured such that the optical signal does not overlap with the pumping signal and/or a dispersion signal corresponding to the pumping signal. For example, a range of pumping wavelengths of the pumping signal may be adjusted according to a range of input wavelengths such that the range of input wavelengths does not overlap with the range of pumping wavelengths and/or a dispersion range of wavelengths corresponding to the pumping signal. Additionally or alternatively, bandwidths of the pumping signal may be adjusted to be narrower such that the pumping signal and the dispersion signal corresponding to the pumping signal do not overlap with the optical signal.

Embodiments of the present disclosure will be explained with reference to the accompanying drawings.

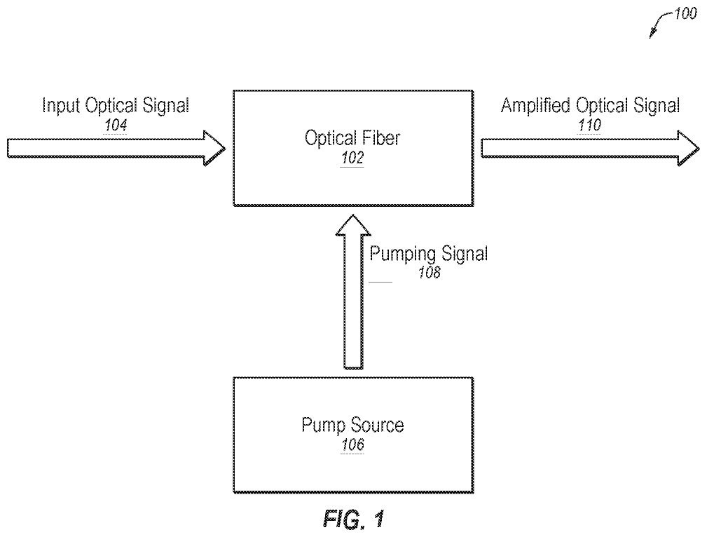

FIG. 1 illustrates an example embodiment of an optical amplification system 100 configured to perform pumping of optical signals, in accordance with at least one embodiment of the present disclosure. The optical amplification system 100 may include an optical fiber 102, and a pump source 106.

In general, the optical amplification system 100 may be configured to generate a pumping signal 108 that may amplify an optical signal 104 to generate an amplified optical signal 110. In some embodiments, the optical amplification system 100 may be included in any suitable optical device. For example, the optical amplification system 100 may be included in any suitable Raman amplifier configured to apply a Raman amplification to an optical signal.

The optical signal 104 may include any optical signal configured to carry data. For example, the optical signal 104 may include an optical signal generated by a light emitting diode (LED), a laser such as a laser diode, having data modulated thereon and/or other similar optical signals. In some embodiments, the optical signal 104 may be generated by a transmitting source, such as an optical transmitter, configured to convey data and/or information over an optical network.

In some embodiments, the optical signal 104 may include a first wavelength range. For example, the optical signal 104 may include wavelengths within approximately 1525 nm to 1565 nm, which may be commonly referred to as the C-band of optical communications. Additionally or alternatively, the optical signal 104 may include a second wavelength range within approximately 1570 nm to 1610 nm, which may be commonly referred to as the L-band or optical communications. In these and other embodiments, first wavelengths of the first wavelength range and second wavelengths of the second wavelength range may be amplified by a pumping signal 108 generated by the pump source 106. For instance, an interaction between the optical signal 104 and the pumping signal 108 within the optical fiber 102 may produce an amplified optical signal 110.

In some embodiments, the pump source 106 may include a light source generator that may be configured to produce the pumping signal 108. For example, the pump source 106 may include a laser device that may be configured to produce and/or output a pumping signal, such as the pumping signal 108. In some embodiments, the pump source 106 may include a broadband laser such that the pumping beam 108 may include a broad range of wavelengths. In some embodiments, the pump source 106 may include a light source generator that may be configured to produce the pumping signal 108. For example, the pump source 106 may include a laser device that may be configured to produce and/or output a pumping beam, such as the pumping signal 108. In some embodiments, the pump source 106 may include a broadband laser such that the pumping beam 108 may include a broad range of wavelengths. In some embodiments, the pump source 106 may be configured to produce the pumping signal 108 as an incoherent pumping signal. For example, the pump source 106 may produce an incoherent, broadband pumping signal that may be the pumping signal 108 of the optical amplification system 100. In some embodiments, the incoherent pumping signal may include a wide bandwidth (e.g., 20-30 nm). In some embodiments, the pump source 106 may include a Fabry-Perot (FP) laser which may generate the pumping signal 108 with a narrower bandwidth compared to the incoherent pumping signal (e.g., 5 nm to 10 nm). In other embodiments, the pump source 106 may include a Fiber Bragg Grating (FBG) laser which may generate the pumping signal 108 with a narrower bandwidth (e.g., less than or equal to 3 nm).

In some embodiments, the optical fiber 102 may include an optical medium for transmitting light signal, such as glass or plastic. In some embodiments, the optical fiber 102 may include a dispersion-shifted fiber (DSF). Additionally or alternatively, the optical fiber 102 may include a non-zero DSF. The non-zero DSF may allow non-zero dispersion to be shifted to specific wavelengths to optimize signal transmission characteristics. In some embodiments, the optical fiber 102 may include a zero-dispersion wavelength (ZDW) in vicinity of 1500 nm.

In some embodiments, the first wavelength range of the optical signal 104 may not include the ZDW of the optical fiber 102. For example, in instances with the ZDW at 1500 nm, the first wavelength range may not include 1500 nm. In some embodiments, including the ZDW within the first wavelength range may help reduce pulse dispersion of the optical signal 104, which may help maintain signal quality and enable high data rates. However, aligning the optical signal 104 with the ZDW may cause increased susceptibility to nonlinear effects of the optical signal 104. For example, self-phase modulation and cross-phase modulation may apply more which may cause signal distortion and degrade signal quality.

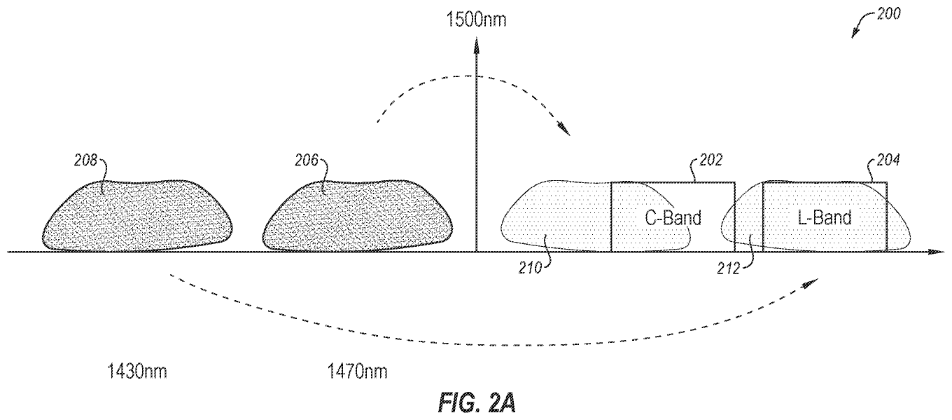

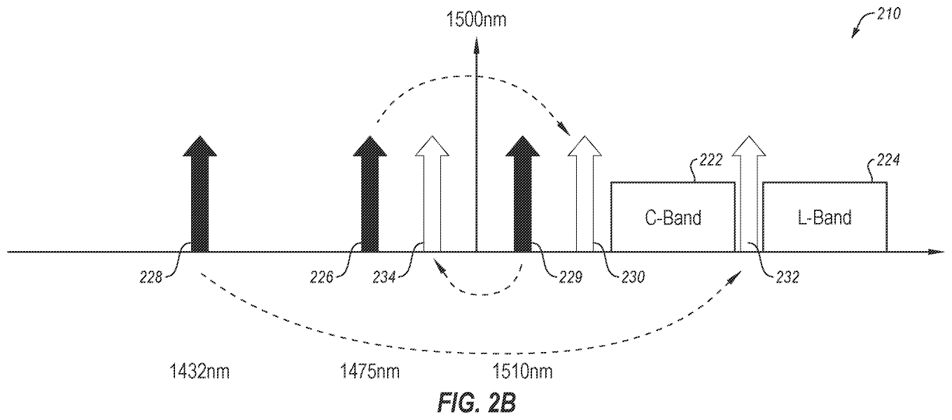

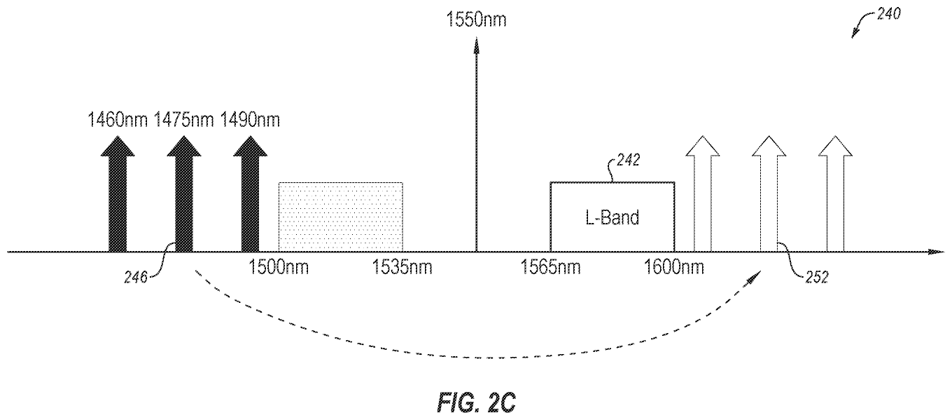

Some traditional implementations of Raman amplifiers may include use of incoherent pumps which may include a wide bandwidth (e.g., 20-30 nm). For example, a pumping signal generated by the incoherent pumps may include a range of pumping wavelengths that is around 20-30 nm wide. For example, FIG. 2A illustrates an example of a Raman amplifier with the incoherent pumps.

FIG. 2A illustrates an example graph 200 representing different optical signals and pumping signals. For instance, the graph 200 includes a first range of optical signal wavelengths 202 (“first signal wavelengths 202”) representing the C-band and a second range of optical signal wavelengths 204 (“second signal wavelengths 204”) representing the L-band. The graph 200 further illustrates a first range of pumping wavelengths 206 (“first pumping wavelengths 206”) representing a wavelength range around 1470 nm. For instance, the first pumping wavelengths 206 may include a range of 20-30 nm with a center point around 1470 nm.

Additionally or alternatively, a pumping signal may include a second pumping range of wavelengths 208 (“second pumping wavelengths 208”). The second pumping wavelengths 208 may represent a wavelength range around 1430 nm. For instance, the second pumping wavelengths 208 may include a range of 20-30 nm with a center point around 1430 nm.

The pumping signal including the first pumping wavelengths 206 and/or the second pumping wavelengths 208 may have a first range of dispersion wavelengths 210 (“first dispersion wavelengths 210”) and/or a second range of dispersion wavelengths 212 (“second dispersion wavelengths 212”) therewith, respectively. The first dispersion wavelengths 210 and the second dispersion wavelengths 212 may represent dispersion of the first pumping wavelengths 206 and the second pumping wavelengths 208, respectively. In some instances, the dispersion may occur and/or be illustrated with respect to ZDW of optical fiber the optical signals and the pumping signals are propagating through.

For example, the ZDW of the optical fiber may be 1500 nm. For instance, the optical signals and/or the pumping signals traveling through the optical fiber may experience different levels of dispersion depending on how close their corresponding wavelengths are to the ZDW of 1500 nm. For example, the different wavelengths of the optical signals and the pumping signals may travel at different speed and/or disperse to different speeds as the wavelengths get shorter or longer away from the ZDW. For instance, the first dispersion wavelengths 210 may represent dispersion of the first pumping wavelengths 206 with respect to the ZDW in which the first dispersion wavelengths 210 are “reflected” across the ZDW as compared to the first pumping wavelengths 206. Similarly, the second dispersion wavelengths 212 may represent dispersion of the second pumping wavelengths 208 with respect to the ZDW in which the second dispersion wavelengths 212 are reflected across the ZDW as compared to the second pumping wavelengths 208.

As illustrated in FIG. 2A, the first dispersion wavelengths 210 and/or the second dispersion wavelengths 212 may overlap with the first signal wavelengths 202 and/or the second signal wavelengths 204. Such an overlap may cause increased noise to the optical signals. As such, FIG. 2A illustrates some issues that may be caused by a traditional approach of using incoherent pumps.

Returning to FIG. 1, the pumping signal 108 may be adjusted to reduce and/or eliminate overlap between the pumping signal 108 and the optical signal 104, as well as between a dispersion signal associated with the pumping signal 108 and the optical signal 104. For example, the pump source 106 may be configured to adjust the pumping signal 108. The dispersion signal associated with the pumping signal 108 may be adjusted according to the pumping signal 108. In these and other embodiments, the pumping signal 108 may be adjusted using any suitable methods. For example, in instances with the pump source 106 as the FP-laser, oscillation wavelengths of the FP-laser may be adjusted by changing laser temperature. For instance, by tuning the laser temperature from 25° C. to 65° C., the oscillation wavelengths of the FP-laser may be adjusted and/or shifted by 20 nm.

Additionally or alternatively, a bandwidth of the pumping signal 108 may be adjusted to be narrower to reduce the overlap. In some embodiments, optical filters may be used to the reduce the bandwidth. In these and other embodiments, any suitable optical filters may be used to reduce and/or adjust the bandwidth. For example, the optical filters may include narrowband optical filters, etalon filters, Fiber Bragg Gratings, dichroic filters, diffraction gratings, tunable filters, among others.

For example, FIG. 2B illustrates an example graph 210 representing adjusted pumping signal. In some embodiments, the graph 210 may include a first optical signal 222 and a second optical signal 224. In some embodiments, the first optical signal 222 may correspond to the C-band and the second optical signal 224 may correspond to the L-band of the optical communication. In some embodiments, the first optical signal 222 and/or the second optical signal 224 may be transmitted through an optical fiber. In some embodiments, the optical fiber may include a ZDW of 1500 nm.

In some embodiments, one or more pumping signals may be transmitted through the optical fiber along with the first optical signal 222 and/or the second optical signal 224 to amplify the first optical signal 222 and/or the second optical signal 224. For example, a first pumping signal 226, a second pumping signal 228 and/or a third pumping signal 229 may be transmitted through the optical fiber. In these and other embodiments, the pumping signals may include wavelengths such that the pumping signals and dispersion signals corresponding to the pumping signals do not overlap with the first optical signal 222 and/or the second optical signal 224.

For example, the first pumping signal 226 may be generated and/or transmitted at a wavelength of 1475 nm. For instance, the first pumping signal 226 may include a first range of pumping wavelengths including 1475 nm. In these and other embodiments, the first pumping signal 226 may be dispersed with respect to the ZDW (e.g., 1500 nm) of the optical fiber. In some embodiments, a first dispersion signal 230 may correspond to the first pumping signal 226. In these and other embodiments, the first dispersion signal 230 may be on an opposite side of the ZDW as compared to the first pumping signal 226 such that the first dispersion signal 230 may be “reflected” across the ZDW with respect to the first pumping signal 226. For example, the first pumping signal 226 of 1475 nm may be 25 nm shorter than the ZDW of 1500 nm. The “reflection” may be such that the first dispersion signal 230 may include a first range of dispersion wavelengths including 1525 nm, which may be 25 nm longer than the ZDW of 1500 nm.

In some embodiments, the first dispersion signal 230 may have a bandwidth corresponding to a bandwidth of the first pumping signal 226. For example, in some embodiments, the first pumping signal 226 may be generated using a FP-laser which may generate the first pumping signal with a bandwidth approximately between 5 nm to 10 nm. For instance, the first range of pumping wavelengths may range from 1470 nm to 1480 nm. Accordingly, the first range of dispersion wavelengths may range from 1520 nm to 1530 nm. In these and other embodiments, the first dispersion signal 230 may interact with the first optical signal 222 which may range from 1525 nm to 1565 nm (e.g., the C-band). In these and other embodiments, the overlap may lead to interaction between the first optical signal 222 and the first dispersion signal 230, which may increase noise for the first optical signal 222.

In these and other embodiments, the first pumping signal 226 may be adjusted which may adjust the first dispersion signal 230 accordingly, such that the first dispersion signal 230 does not overlap with the first optical signal 222. In some embodiments, the pumping signal 226 may be adjusted and/or shifted to eliminate the overlap between the first dispersion signal 230 and the first optical signal 222. For instance, the first pumping signal 226 may be shifted by 20 nm toward the ZDW which may also shift the first dispersion signal 230 toward the ZDW by 20 nm. By shifting the first dispersion signal 230, the overlap between the first dispersion signal 230 and the first optical signal 222 may be avoided.

In some embodiments, the shifting and/or the adjusting may be done using any methods suitable for shifting wavelengths of the signals. For example, the FP-laser may be temperature sensitive such that the first pumping signal 226 may be tuned by changing laser temperature. For example, by turning the laser temperature from 25° C. to 65° C., the first range of pumping wavelengths may be shifted by 20 nm toward the ZDW. For example, the first range of pumping wavelengths may range from 1490 nm to 1500 nm and the first range of dispersion wavelengths may range from 1500 nm to 1510 nm, avoiding overlap with the first optical signal.

In some embodiments, such shifting of the first pumping signal 226 may lead to the first pumping signal 226 and/or the first dispersion signal 230 overlapping with the ZDW (e.g., 1500 nm). In these and other embodiments, bandwidths of the first pumping signal 226 may be adjusted to avoid the overlap. For example, one or more optical filters may be applied to the first pumping signal 226. For instances, optical filters such as narrowband interference filters, etalon filters, Fiber Bragg Gratings, distributed feedback lasers, fiber Fabry-Perot filters, among others may be applied to the pump source to adjust the bandwidth of the first pumping signal 226 and the first dispersion signal 230 accordingly. For example, the bandwidths of the first pumping signal 226 and the first dispersion signal 230 may be adjusted to be around 5 nm, which may allow the first dispersion signal 230 to avoid the overlap with the ZDW as well as the first optical signal 222. For instance, the first range of pumping wavelengths may range from 1490 nm to 1495 nm and the first range of dispersion bandwidth may range from 1505 nm to 1510 nm.

In some embodiments, the graph 210 may illustrate a second pumping signal 228 and a second dispersion signal 232 associated with the second pumping signal 228. In these and other embodiments, the second dispersion signal 232 may be on an opposite side of the ZDW as compared to the second pumping signal 228 such that the second dispersion signal 232 may be “reflected” across the ZDW with respect to the second pumping signal 228. For example, the second pumping signal 228 of 1432 nm may be 68 nm shorter than the ZDW of 1500 nm. The “reflection” may be such that the second dispersion signal 232 may include a second range of dispersion wavelengths including 1568 nm, which may be 68 nm longer than the ZDW of 1500 nm.

In some embodiments, the second pumping signal 228 may be adjusted similar to the first pumping signal 226 such that the second dispersion signal 232 does not overlap with the first optical signal 222 and/or the second optical signal 224. In instances where the first optical signal 222 and the second optical signal 224 correspond to the C-band and the L-band respectively, the second pumping signal 228 which may include a second range of pumping wavelengths may be adjusted such that the second pumping signal 232 may fall between the first optical signal 222 and the second optical signal 224 (e.g., between the C-band and the L-band). In these and other embodiments, a second range of dispersion wavelengths corresponding to the second dispersion signal 232 may be adjusted to range within a gap between the first optical signal 222 and the second optical signal 224. In some embodiments, the gap may be relatively narrow (e.g., less than or equal to 5 nm). In such instances, the second pumping signal 228 may be shifted and/or narrowed such that the second dispersion signal 232 does not overlap with the first optical signal 222 and/or the second optical signal 224.

In some embodiments, a pumping signal may be on same side of the ZDW as the first optical signal 222 and/or the second optical signal 224. For example, a third pumping signal 229 include a third range of pumping wavelengths including 1510 nm. In these instances, a third dispersion signal 234 corresponding to the third pumping signal 229 may be on other side of the ZDW (e.g., shorter than the ZDW).

Returning to FIG. 1, in some embodiments, the ZDW may vary based at least on type of the optical fiber 102. For example, the optical fiber 102 may be the DSF in which the ZDW may be around 1550 nm. In these instances, the optical signal 104 may not include signals over the C-band to avoid overlap with the ZDW. In these and other embodiments, the bands of the optical communication may be used for the optical signal 104. For example, the optical signal 104 may include signals in the L-band.

For example, FIG. 2C illustrates an example graph 240 with a first optical signal 242 in the L-band. In some embodiments, the L-band range may vary approximately from 1565 nm to 1600 nm. For instance, the range of the L-band may be narrower (e.g., 1570 nm to 1600 nm) or wider (e.g., 1565 nm to 1605 nm).

In some embodiments, a pumping signal used to amplify the first optical signal 242 may be adjusted accordingly to avoid overlap with the first optical band 242 and/or the ZDW (e.g., 1550 nm). For instance, a first pumping signal 246 and a first dispersion signal 252 corresponding to the first pumping signal 246 may be adjusted to avoid overlap with the first optical signal 242 (e.g., the L-band) and/or the ZDW.

Modifications, additions, or omissions may be made to the optical amplification system 100 without departing from the scope of the present disclosure. For example, in some embodiments, the optical amplification system 100 may include any number of other components that may not be explicitly illustrated or described.

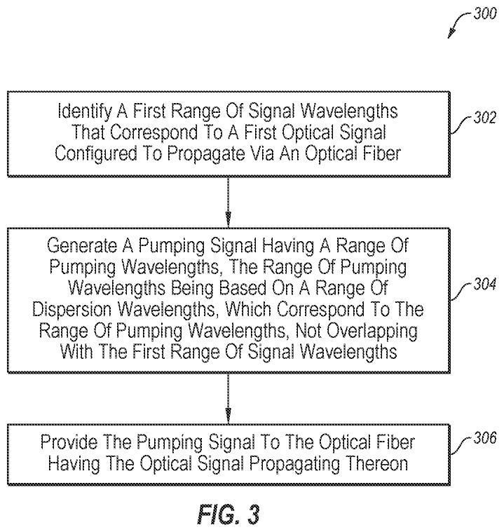

FIG. 3 is a flow chart of an example method 300 of performing optical pumping, arranged in accordance with at least one embodiment of the present disclosure. The method 300 may be implemented by any suitable element of an optical pumping system such as the optical amplification system 100 of FIG. 1 as described above. Although illustrated as discrete steps, various steps of the method 300 may be divided into additional steps, combined into fewer steps, or eliminated, depending on the desired implementation. Additionally, the order of performance of the different steps may vary depending on the desired implementation.

In some embodiments, the method 300 may begin at block 302. At block 302, a first range of signal wavelengths that correspond to a first optical signal configured to propagate via an optical fiber may be identified. In some embodiments, the first range of signal wavelengths may vary based at least on a type of the optical fiber. For instance, the optical fiber may amplify certain optical signals within certain wavelengths better than other wavelengths. The first range of signal wavelengths may be selected and/or identified to correspond to wavelengths that the optical fiber may amplify. For instance, different types of optical fibers may amplify different wavelengths. For example, a non-zero dispersion-shifted fibers (NZ-DSF) may be suitable to amplify signals within wavelengths of the L-band of optical transmission bands. In these and other embodiments, the first range of signal wavelengths may correspond to the L-band of optical transmission bands. The optical fiber may include any suitable types of optical fiber that may be used to amplify optical signals. In some embodiments, the first range of signal wavelengths may be selected according to different types of optical fibers.

In some embodiments, a second range of signal wavelengths corresponding to a second optical signal may be selected and/or identified to correspond to wavelengths that the optical fiber may amplify. For example, in some instances, the optical fiber may include a standard single-mode fiber (SMF), which may be suitable to amplify signals within the wavelengths corresponding to the L-band and the C-band of optical transmission bands. In some embodiments, the second range of signal wavelengths may be different from the first range of signal wavelengths. For example, in some embodiments, the second range of wavelengths may correspond to the C-band.

At block 304, a pumping signal having a range of pumping wavelengths may be generated. In some embodiments, the range of pumping wavelengths may be determined based at least on a range of dispersion wavelengths corresponding to the range of pumping wavelengths not overlapping with the first range of signal wavelengths, such as described in the present disclosure with respect to FIGS. 1 and 2A-2C.

In some embodiments, the range of dispersion wavelengths may correspond to a relationship between the range of pumping wavelength and a zero-dispersion wavelength (ZDW) that correspond to the optical fiber. For instance, the ZDW of the optical fiber may be such that signals traveling through the optical fiber experience the least dispersion. For instance, the signals may include ranges of wavelengths including different wavelengths as the signals enter a medium such as the optical fiber. As the signals travel through the optical fiber, different wavelengths within the signals may travel at different speeds, causing a group velocity dispersion. For example, the signals may experience a positive group velocity dispersion where shorter wavelengths travel faster than longer wavelengths and/or a negative group velocity dispersion where longer wavelengths travel faster than shorter wavelengths. The ZDW may represent a specific wavelength at which the group velocity dispersion may be substantially zero.

In some embodiments, the dispersion of the signals may occur with respect to the ZDW. For example, the range of dispersion wavelengths may be “reflected” across the ZDW as compared to the range of pumping wavelengths. In these and other embodiments, the range of pumping wavelengths may be generated such that the range of pumping wavelengths and/or the range of dispersion wavelengths do not overlap with the first range of signal wavelengths and/or the second range of signal wavelengths, such as described in the present disclosure with respect to FIGS. 1 and 2A-2C.

In some embodiments, a pumping source generating the pumping signal may be configured to generate the pumping signal at a certain wavelength range. In some embodiments, the certain wavelength range may not be suitable in that the range of pumping wavelengths and/or the range of dispersion wavelengths overlap with the first range of signal wavelengths and/or the second range of signal wavelengths. In these and other embodiments, the range of pumping wavelengths may be adjusted by adjusting the pumping source. For instance, the adjustment may be made to move the range of pumping wavelengths such that corresponding range of dispersion wavelengths does not overlap with the first range of signal wavelengths and/or the second range of signal wavelengths. In some embodiments, the range of pumping wavelengths may be modified by modifying a temperature of the pumping source and/or a laser used to generate the pumping signal. In some embodiments, any other suitable methods may be used to adjust the pumping signal. Additionally or alternatively, bandwidths of the pumping signal may be adjusted (e.g., to be narrower). For example, one or more optical filters may be used to adjust the bandwidths.

At block 306, the pumping signal may be provided to the optical fiber having the optical signal propagating thereon. For instance, the pumping signal may be used to amplify the first optical signal and/or the second optical signal. For example, the pumping signal may interact with molecules and/or ions of the optical fiber which may cause scattering of energy of the pumping signal. Scattered energy may be transferred from the pumping signal to the optical signal, amplifying the optical signal.

Modifications, additions, or omissions may be made to the method 300 without departing from the scope of the present disclosure. For example, the outlined steps and operations are only provided as examples, and some of the steps and operations may be optional, combined into fewer steps and operations, or expanded into additional steps and operations without detracting from the essence of the disclosed embodiments.

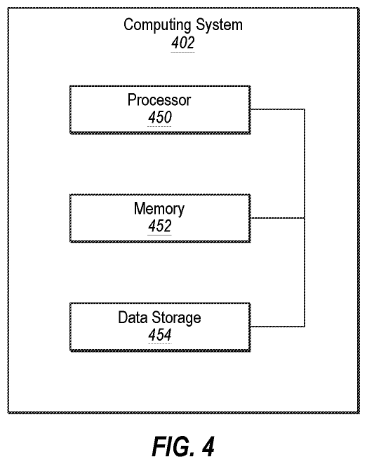

FIG. 4 illustrates a block diagram of an example computing system 402, according to at least one embodiment of the present disclosure. The computing system 402 may be configured to implement or direct one or more suitable operations described in the present disclosure. For example, the computing system 402 may be configured to direct the pumping source 106 to adjust the wavelengths of the pumping signal 108 as described and illustrated in FIG. 1 above. The computing system 402 may include a processor 450, a memory 452, and a data storage 454. The processor 450, the memory 452, and the data storage 454 may be communicatively coupled.

In general, the processor 450 may include any suitable special-purpose or general-purpose computer, computing entity, or processing device including various computer hardware or software modules and may be configured to execute instructions stored on any applicable computer-readable storage media. For example, the processor 450 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 4, the processor 450 may include any number of processors configured to, individually or collectively, perform or direct performance of any number of operations described in the present disclosure. Additionally, one or more of the processors may be present on one or more different electronic devices, such as different servers.

In some embodiments, the processor 450 may be configured to interpret and/or execute program instructions and/or process data stored in the memory 452, the data storage 454, or the memory 452 and the data storage 454. In some embodiments, the processor 450 may fetch program instructions from the data storage 454 and load the program instructions in the memory 452. After the program instructions are loaded into memory 452, the processor 450 may execute the program instructions.

The memory 452 and the data storage 454 may include computer-readable storage media for carrying or having computer-executable instructions or data structures stored thereon. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other non-transitory storage medium which may be used to carry or store particular program code in the form of computer-executable instructions or data structures and which may be accessed by a general-purpose or special-purpose computer. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007).

Combinations of the above may also be included within the scope of computer-readable storage media. Computer-executable instructions may include, for example, instructions and data configured to cause the processor 450 to perform a certain operation or group of operations.

Modifications, additions, or omissions may be made to the computing system 402 without departing from the scope of the present disclosure. For example, in some embodiments, the computing system 402 may include any number of other components that may not be explicitly illustrated or described.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Additionally, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B” even if the term “and/or” is used elsewhere.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method comprising:
identifying a first range of signal wavelengths that correspond to a first optical signal configured to propagate via an optical fiber;
generating a pumping signal having a range of pumping wavelengths,
the range of pumping wavelengths being based on a range of dispersion wavelengths that correspond to the range of pumping wavelengths,
the dispersion wavelengths not overlapping with the first range of signal wavelengths; and
providing the pumping signal to the optical fiber having the first optical signal propagating thereon.

2. The method of claim 1, wherein the range of pumping wavelengths is further based on the range of dispersion wavelengths not overlapping a second range of signal wavelengths that correspond to a second optical signal configured to propagate via the optical fiber.

3. The method of claim 2, wherein:
the first range of signal wavelengths corresponds to the L-band of optical transmission bands; and
the second range of signal wavelengths corresponds to the C-band of optical transmission bands.

4. The method of claim 1, wherein the range of dispersion wavelengths corresponds to a relationship between the range of pumping wavelengths and a zero-dispersion wavelength that corresponds to the optical fiber.

5. The method of claim 1, wherein a previous range of pumping wavelengths is modified to obtain the range of pumping wavelengths based on a previous range of dispersion wavelengths that correspond to the previous range of pumping wavelengths overlapping the first range of signal wavelengths.

6. The method of claim 5, wherein the previous range of pumping wavelengths is modified to obtain the range of pumping wavelengths by modifying a temperature of a laser used to generate the pumping signal.

7. The method of claim 1, wherein:
the range of pumping wavelengths is on a first side of a zero-dispersion wavelength that corresponds to the optical fiber; and
the first range of signal wavelengths is on a second side of the zero-dispersion wavelength.

8. The method of claim 1, wherein the first range of signal wavelengths corresponds to the L-band of optical transmission bands.

9. The method of claim 1, wherein the first range of signal wavelengths corresponds to the C-band of optical transmission bands.

10. The method of claim 1, wherein the range of dispersion wavelengths corresponds to a group velocity dispersion of the range of pumping wavelengths.

11. An optical pumping system comprising:
a pumping laser configured to generate a pumping signal having a range of pumping wavelengths,
the range of pumping wavelengths being based on a range of dispersion wavelengths that correspond to the range of pumping wavelengths,
the dispersion wavelengths not overlapping with a first range of signal wavelengths that correspond to a first optical signal configured to propagate via an optical fiber; and
an optical coupler configured to cause the pumping signal to propagate through the optical fiber.

12. The optical pumping system of claim 11, wherein the range of pumping wavelengths is further based on the range of dispersion wavelengths not overlapping a second range of signal wavelengths that correspond to a second optical signal configured to propagate via the optical fiber.

13. The optical pumping system of claim 12, wherein:
the first range of signal wavelengths corresponds to the L-band of optical transmission bands; and
the second range of signal wavelengths corresponds to the C-band of optical transmission bands.

14. The optical pumping system of claim 11, wherein the range of dispersion wavelengths corresponds to a relationship between the range of pumping wavelengths and a zero-dispersion wavelength that corresponds to the optical fiber.

15. The optical pumping system of claim 11, wherein a previous range of pumping wavelengths is modified to obtain the range of pumping wavelengths based on a previous range of dispersion wavelengths that correspond to the previous range of pumping wavelengths overlapping the first range of signal wavelengths.

16. The optical pumping system of claim 15, wherein the previous range of pumping wavelengths is modified to obtain the range of pumping wavelengths by modifying a temperature of a laser used to generate the pumping signal.

17. The optical pumping system of claim 11, wherein:
the range of pumping wavelengths is on a first side of a zero-dispersion wavelength that corresponds to the optical fiber; and
the first range of signal wavelengths is on a second side of the zero-dispersion wavelength.

18. The optical pumping system of claim 11, wherein the first range of signal wavelengths corresponds to the L-band of optical transmission bands.

19. The optical pumping system of claim 11, wherein the first range of signal wavelengths corresponds to the C-band of optical transmission bands.

20. The optical pumping system of claim 11, wherein the range of dispersion wavelengths is generated from a group velocity dispersion of the range of pumping wavelengths.
